(19) United States
(12) Patent Application Publication
(10) Pub. No.: US 2024/0389554 A1
(43) Pub. Date: Nov. 28, 2024

(54) CANINE SOCKS WITH MULTI-PURPOSE PROTECTIVE CONSTRUCTION

(71) Applicants: Alan H. Golden, Potomac, MD (US); Mark A. Litman, Edina, MN (US)

(72) Inventors: Alan H. Golden, Potomac, MD (US); Mark A. Litman, Edina, MN (US)

(21) Appl. No.: 18/202,468

(22) Filed: May 26, 2023

(51) Int. Cl. A01K 13/00; D02G 3/04; D04H 1/4209; D04H 1/4342; D04H 3/002; D04H 3/009

(52) U.S. Cl. CPC A01K 13/007; D02G 3/045; D02G 3/047; D04H 1/4209; D04H 1/4342; D04H 3/002; D04H 3/009; D10B 2331/021; D10B 2401/00; D10B 2401/061; D10B 2501/043

(57) ABSTRACT

Multifunctional protective footwear for canines is provided with a vertical zone, a transition zone and a horizontal zone. At least the horizontal zone, adjacent the pad of a canine's foot contains a combination of at least two fabric materials, a) silicone rubber threads or yarns combined with b) meta- or para-aramids, a) and b) combined within proportions of 5-95% and 95-5% by total fabric weight of the footwear weight respectively. Up to 50% of the total footwear weight may be replaced by other fiber materials, with the combinations of a) and b) constituting the remaining total weight of the footwear as 5-45% and 45-5% by total fabric weight of the footwear weight respectively.

### BACKGROUND OF THE INVENTION

### 1. Field of the Invention

The presently disclosed subject matter is generally directed to lightweight and flexible footwear for canines that provide a broad range of protection for a wide field of activities and locations and conditions.

### BACKGROUND OF THE ART

Dogs have always had a close connection to humankind, providing both companionship and work support. Not only do dogs provide company and protection, but they also hunting support, assist the impaired, have roles in police or military activities, and even can detect medical conditions and locate cadavers. Because of these many different canine activities, and because of either high personal value or economic value attributed to them, dogs should be protected against any type of harm or danger to which they might be exposed. Because they are active in many different environments, a dog's paws must have protection available which can be used in randomly encountered locations as well as with predicted local requirements.

The paws of dogs are complex appendages that provide for mobility, shock absorption, balance, terrain sensing, traction, digging, and pushing objects. Paws may be subject to punctures, cuts, abrasions, tears, frostbite, burns, and blisters caused by uneven surfaces, chemical burns. There is a desire for dog owners or handlers to protect their dogs with footwear, without diminishing the canine's ability to function when performing activities. Dog feet are also highly sensitive, and any footwear must be tolerated by the dog without its repeatedly attempting to remove it, and must not interfere with the dog's highly skilled use of its feet. Prior art attempts to provide shoes for dogs have found little practical utility and have been primarily decorative for owners and not well tolerated by the dogs. Some shoes have difficult to put on the animals, too easily removed by the animals, fail to provide significant protection to the dog's paws in extreme and variable conditions. Many early versions were uncomfortable, and the dog was annoyed, distracted and hampered. It is therefore desirable to provide apparel for a dog's feet and paws that does not have the shortcomings of the prior art.

### SUMMARY OF THE INVENTION

The present invention and technology relate to a dog foot apparel, more like socks than shoes. The apparel, generally referred to as ‘socks’ are comprised of more than 75% by weight of fabric materials (woven, knitted, non-woven and combinations thereof) that exhibit resistance to thermal transfer to a dog's feet (both heat and cold insulation), abrasion resistance, puncture resistance, and chemical resistance, yet are able to be more comfortable to a dog's feet than traditional animal footwear. These benefits are provided by a combination of material selection (especially layering or blending different fabric materials) and structural orientation and positioning of the distinct materials and constructions in the socks.

The socks typically have different areas which may have or even require different compositional and structural properties to perform all of these functions satisfactorily for the dog and the handler. Generally there will be a foot pad section (having at least one and even six or more different elements), a side wall section, which may have at least one and up to 5 or more sections, a heel section, and a leg section. Tightening elements may also be provided. The socks may include a locking element about the leg portion.

In one embodiment, the present invention may be provided as a kit which can be assembled, fitted, and repaired as needed before, during or after use.

Multifunctional protective footwear for canines may be provided with a vertical zone, a transition zone and a horizontal zone. At least the horizontal zone, adjacent the pad of a canine's foot contains a combination of at least two fabric materials, a) silicone rubber threads or yarns combined with b) meta- or para-aramids, a) and b) combined within proportions of 5-95% and 95-5% by total fabric weight of the footwear weight respectively. Up to 50% of the total footwear weight may be replaced by other fiber materials, with the combinations of a) and b) constituting the remaining total weight of the footwear as 5-45% and 45-5% by total fabric weight of the footwear weight respectively.

### BRIEF DESCRIPTION OF THE FIGURES

FIG. 1 shows a side view of a generic embodiment of the present invention, including optional elements.

FIG. 2 shows a tube-sock type construction within the scope of the present invention.

### DETAILED DESCRIPTION OF THE INVENTION

Multifunctional protective footwear for canines is provided with a vertical zone, a transition zone and a horizontal zone. By multifunctional is meant that the wear provides some measurable level of protection against abrasion, surface-contacted heat (at least 150° F.), surface-contacted cold (lowest at −40° F.), puncture resistance (e.g., protection against large glass shards, but not needle puncture resistance), and some light liquid chemical resistance. At least the horizontal zone, adjacent the pad of a canine's foot contains a combination of at least two fabric materials, a) silicone rubber threads or yarns combined with b) meta- or para-aramids, a) and b) combined within proportions of 5-95% and 95-5% by total fabric weight of the footwear weight respectively. Up to 50% of the total footwear weight may be replaced by other fiber materials, with the combinations of a) and b) constituting the remaining total weight of the footwear as 5-45% and 45-5% by total fabric weight of the footwear weight respectively. Puncture resistance is defined herein as preventing penetration of an edge of a 2.0 cm freshly broken glass shard through a fabric when a test fabric is pressed for 30 seconds with five pounds pressure against the glass shard.

Kevlar has a tensile strength of at least 3200 MPa (480.00 psi), and a relative density of at least 1.35 and Kevlar maintains its strength and resilience down to cryogenic temperatures (−196° C. (−320.8° F.)): in fact, it is slightly stronger at low temperatures. At higher temperatures the tensile strength is immediately reduced by about 10-20%, and after some hours the strength progressively reduces further. For example: enduring 160° C. (320° F.) for 500 hours, its strength is reduced by about 10%; and enduring 260° C. (500° F.) for 70 hours, its strength is reduced by about 50%.

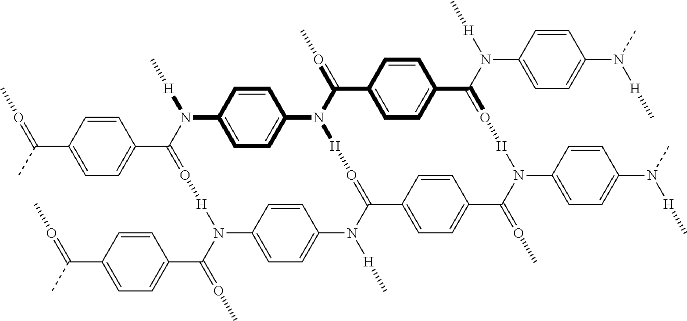

A kit for constructing footwear on site may include: a plurality of soles, each comprising a top face and an opposed bottom face, a toe end, and an opposed heel end; one or more rear flaps, each with a first end and a second end, the first end attached to the heel end of the sole and extending in an upward direction; one or more recloseable cuffs positionable at the second end of the rear flap, each cuff comprising first and second ends, wherein each cuff comprises an open position with the first and second cuff ends opposed from each other and a closed position where the first and second cuff ends of the cuff are attached to form a loop; one or more tongues configured to be attached to the toe end of a sole, each comprising at least one opening and a length defined by an attachment that releasably attaches to a retention element positioned on a front face of the cuff when the cuff is in the closed position; one or more recloseable straps positionable at the second end of the rear flap external to the recloseable cuff, the strap comprising first and second ends, wherein the strap comprises an open position with the first and second strap ends opposed from each other and a closed position where the first end second strap ends are attached to form a loop to close around an exterior surface of the cuff when the cuff is in the closed position and when the tongue attachment is positioned on the front face of the cuff.

As compared to organic rubber, silicone rubber has a Si—O bond in its structure, and hence, it has better:
Heat resistance
Chemical stability
Electrical insulation
Abrasion resistance
Weatherability as well as Ozone resistance

Silicone rubbers can withstand temperatures ranging from −50° C. to 350° C. (depending on the duration of exposure). Parts made of silicone rubber when exposed to wind, rain and UV rays for long periods result in virtually no change in physical properties. Unlike most organic rubbers, silicone rubber is not affected by ozone as well.

Silicone Rubber's special features are hence, originated from its unique molecular structure that they can carry both inorganic and organic properties. The general structure for silicone rubbers (which may also include copolymeric components and units with variations in substituents) comprises:

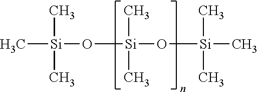

As typical in polymeric structure, ‘n’ is the number of intermediate bridging units. With these unique characteristics, silicone rubber is widely used in industry such as aerospace, automotive, construction, medical, E&E, food processing, etc. Overall silicone rubbers are used in various applications as elastomers, adhesives & sealants, potting, and encapsulating compounds as well as in coatings, lubricants, etc.

Commercial grade Silicone rubbers were first introduced by Dow Corning (now 100% Dow subsidiary) in 1943. Today, silicone rubbers are manufactured by several companies.

### Different Types & Methods Used to Synthesize Silicone Rubbers

The organic groups in silicone rubbers may be methyl, vinyl, phenyl or other groups. According to ASTM D1418 standard, which covers a system of general classification or nomenclature for rubber and rubber lattices, silicone rubbers are classified as:
Methyl Group—Also known as dimethylsilicone elastomer/rubber or simply methyl silicone rubber. It is also referred by MQ.
Methyl and Phenyl Groups—Also known as methyl-phenylsilicone elastomer/rubber or phenysilicone rubber. It is referred as PMQ and it has an excellent low-temperature performance.
Methyl and Vinyl Groups—Also known as methylvinylsilicone/rubber. It is referred as VMQ as well.
Methyl, Phenyl and Vinyl Groups—It is referred as PVMQ as well and is known for its excellent low-temperature performance.
Fluoro, Vinyl and Methyl Groups—Also known as fluorinated rubber or fluorosilicone rubber. It is referred as FVMQ (and accepted as a definition herein for silicone rubbers having at least some measurable fluor-groups, vinyl groups and methyl groups) and they are highly resistant to chemical attack (fuel, oil, solvent . . . ).
   Apart from its molecular structure, another factor for classifying silicone rubber are viscosity and the method employed for their processing. Silicone rubber is available in three main forms:
Solid Silicone Rubber or High-Temperature Vulcanized, HTV—solid silicone rubber contains polymers with a high molecular weight and relatively long polymer chains. They are available in an uncured form and required traditional rubber processing techniques.
Liquid Silicone Rubber, LSR-Liquid Silicone Rubber contains polymers of lower molecular weight and hence shorter chains. It has better flow properties. It is processed on specially designed injection molding and extrusion equipment.
Room Temperature Vulcanized, RTV-RTV silicone rubber is a type of silicone rubber made from one-part (RTV-1) or two-component (RTV-2) systems where their hardness range of very soft to medium. They are available for potting, encapsulations, sealants etc.

Liquid Silicone Rubber maintains mechanical properties over a wide range of temperatures (from −50° C. to 250° C.). This heat-cured elastomer provides excellent optical clarity, durability and design freedom. Silicone rubbers are flexible and durable from temperatures between −100 to 300° C. (−150 to 570° F.). Silicone rubber has low tensile strength, poor wear and tear properties.

A preferred silicone thread is Muriel® silicone thread from LeMur S.R.L. in Italy. Among the specific classes of these silicone polymers are Muriel® TS which is designed for its broad range of thermal stability. Muriel® MED which is hypoallergenic and has a more fashionable appearance, Muriel® MF which is more flame resistant, Muriel® RAY which has the highest resistance to chemicals and UV and IR radiation in the brand, and Muriel® GRIP which has a high level of grip against most surfaces and is hydrophobic.

Nomex® is a flame-resistant meta-aramid polymer developed in the early 1960's. Nomex® and related aramid polymers are related to nylon, but have aromatic rather than linear backbones, and hence are more rigid and more durable. Nomex is an example of a meta variant of the aramids (Kevlar® is a para-aramid). Unlike Kevlar®, Nomex® strands cannot align during filament polymerization and have less strength: its ultimate tensile strength is 340 MPa. However, it has excellent thermal, chemical, and radiation resistance for a polymer material. It can withstand temperatures of up to 370° C. The preferred minimum ultimate strength for the aramid class of fabric component is at least 300 MPa.

Both classes of aramid polymers have a useful level of chemical resistance, so that contact with a 2 micron contaminating acid, base or toxin should not allow rapid penetration of the fabric material to contact the canine's paw.

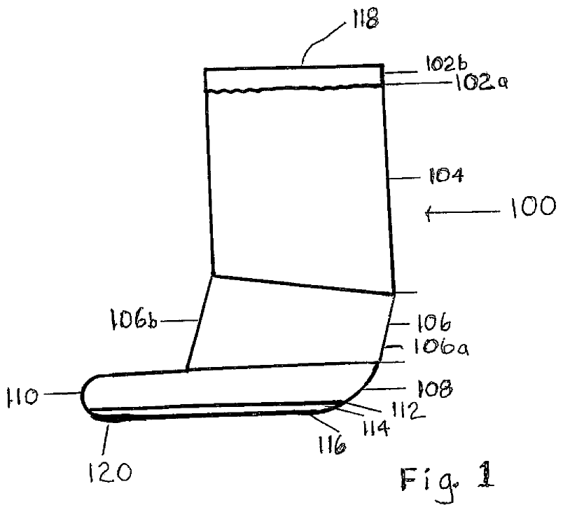

FIG. 1 shows a side view of a generic embodiment of canine protective footwear 100 of the present invention, including optional elements. Shown in the footwear 100 are a vertical zone 104, a transition zone 106 and a horizontal zone 108. The term ‘zone’ is used to reflect that the entire footwear 100 may be constructed of a single manufactured and shaped fabric material, or may be produced by combining materials with distinct properties as each of the three identified zones 104, 106 and 108. An optional topmost elastic layer 102b and a separation line 102 from the vertical zone 104 is shown. There is an optional toe or claw forward rounded exterior on the horizontal zone 108.

In addition, there are optional elements such a padding layer 114 with a transition or connection line 112 below the horizontal zone 108. There is an optional coating or coated layer or fused layer 116 at the lowest point on the horizontal zone 108. There is an opening 118 at the top of the vertical zone 104.

Although the three distinct zones are referenced, one of the broadest scopes of the invention includes a single fabric material formed into the three respective zones, with seaming work, manufactured form, or mechanical shaping forming whatever shaping to accommodate the bending or directional changing in elements 106a, 106b and in the rear end of the horizontal zone 108 and any rounding in the tow or claw region 110.

Another aspect of a broad concepts in the practice and enablement of the present invention includes the use of at least two uniquely combined fabric materials in at least the horizontal zone 108 and preferably in the intermediate zone 106 and as needed, in the horizontal zone 104. The two fabric materials are a) silicone rubber threads or yarns combined with b) meta- or para-aramids, a) and b) combined within proportions of 5-95% and 95-5% by total fabric weight of the footwear weight respectively. Up to 50% of the total footwear weight may be replaced by other fiber materials, with the combinations of a) and b) constituting the remaining total weight of the footwear. A thicker fabric or thicker coating 120 may be on the front od the lowest surface of the construction.

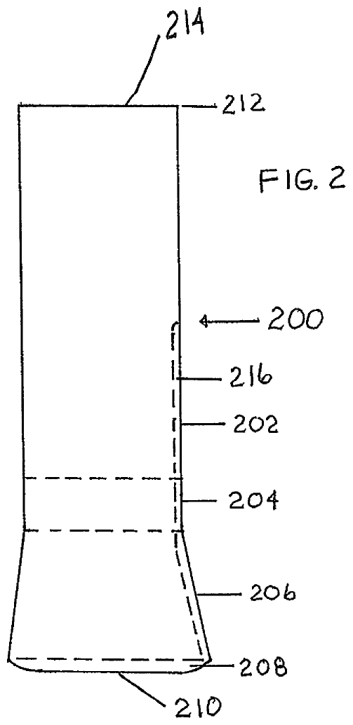

FIG. 2 shows a tube-sock type sock 200 construction within the scope of the present invention. Again, this is a generic representation and proportions are not critical unless numbers and dimensions are provided. are provided. There is an opening 214 for leg and paw insertion at the top 212 of the construction 200. There is again a generally upper section 202, a transitional section 202 and a paw covering section 208 with a lowest surface 210. There is also shown a back-of-the-leg strip 216 of fabric, where additional protection may be provided. A stronger blend of filaments, yarns or fabrics may be used in the strip 216 through one, two or all three sections 202, 204 and 206 of the sock 200. The transitional section 204 may be made more elastic, may be less than 15%, less than 10% and at least 2% of the total length of the sock 200 to provide a region transitioning from the leg to the paw, where the fabric can better reduce puckering with a stronger, tighter, elastic memory than the other two section.

Another general description of a practice of the present invention is as a sock for use on a canine comprising a) a fabric bottom section, b) a fabric surrounding section, c) a top section, and d) a fabric leg section, wherein:
a) the fabric bottom section comprises at least 75% by total weight of the bottom section as a combination of two different fabric materials, a first fabric material having a tensile strength of greater than 300 MPa and less than 2000 MPa and an elongation to break of between 20% and 700% and 4.3%, and the second fabric having a tensile strength of at least 3200 MPa (480.00 psi), an elongation to break of between 1.0 and 4.3%, and a relative density of at least 1.35; and
b) the fabric surrounding section comprising fabric material having form-fitting elasticity and at least chemical resistance that allows the fabric to maintain at least 75% of its elasticity for at least one minute at 30 C when exposed to a solution of 92% alcohol and 8% water;
c) the top section comprising a fabric; and
d) the fabric leg section has sufficient form-fitting elasticity as to support a stationary 20 gram weight on the fabric for 5 minutes when attached two inches below a highest point of contact of the fabric leg section and a canine's leg.
   Further protection and gripping ability may be provided to the horizontal zone by applying coatings (e.g., from 1 micron to 2.0 mm) of a soft, flexible elastomeric material such as a fluoroelastomer, silicone elastomer, polyurethane elastomer, and other synthetic (less preferred polybutadiene, acrylonitrile, styrene elastomers) or natural elastomers (rubber, gums, etc.). Liquid coatings may also provide some further temporary benefits, especially where specific known toxic materials are to be present along a path taken by the canine.

What is claimed:

1. Multifunctional protective footwear for canines provided with a vertical zone, a transition zone and a horizontal zone, wherein at least the horizontal zone, configured in the protective footwear to be adjacent a pad of a canine's foot, contains a combination of at least two fabric materials, a) silicone rubber threads or yarn combined with b) meta- or para-aramid threads or yarn, wherein a) and b) combined within proportions of 5-95% and 95-5% by total fabric weight of the footwear weight respectively.

2. The footwear of claim 1 wherein at least 10% by total weight of the silicone rubber threads or yarn consist of silicone rubbers containing fluoro, vinyl and methyl groups.

3. The footwear of claim 1 wherein the aramid threads or yarn comprises a meta-aramid.

4. The footwear of claim 1 wherein the aramid threads or yarn comprises a para-aramid.

5. The footwear of claim 1 wherein the aramid threads or yarn comprises a blend of meta-aramid and meta-aramid.

6. The footwear of claim 1 comprising a tube sock construction.

7. A sock for use on a canine comprising a) a fabric bottom section, b) a fabric surrounding section, c) a top section, and d) a fabric leg section, wherein:
e) the fabric bottom section comprises at least 75% by total weight of the bottom section as a combination of two different fabric materials, a first fabric material having a tensile strength of greater than 300 MPa and less than 2000 MPa and an elongation to break of between 20% and 700% and 4.3%, and the second fabric having a tensile strength of at least 3200 MPa (480.00 psi), an elongation to break of between 1.0 and 4.3%, and a relative density of at least 1.35; and
f) the fabric surrounding section comprising fabric material having form-fitting elasticity and at least chemical resistance that allows the fabric to maintain at least 75% of its elasticity for at least one minute at 30 C when exposed to a solution of 92% alcohol and 8% water;
g) the top section comprising a fabric; and
h) the fabric leg section has sufficient form-fitting elasticity as to support a stationary 20 gram weight on the fabric for 5 minutes when attached two inches below a highest point of contact of the fabric leg section and a canine's leg.

8. The sock of claim 7 wherein the top section comprises a fabric that provides puncture resistance and chemical resistance.

9. The sock of claim 8 wherein the leg section providing form-fitting elasticity and puncture resistance.

10. The sock of claim 7 wherein the fabric bottom section and the fabric side section comprise an identical fabric material.

11. The sock of claim 7 wherein the combination in the fabric bottom comprises a blend of polysilicone rubber filaments and aramid polymer filaments.

12. The sock of claim 11 wherein the blend is a non-woven blend of polysilicone rubber filaments and aramid polymer filaments with less than 8% by weight of the total layer present as adhesive securing the filaments of the blend together.
